(19) United States
(12) Patent Application Publication
(10) Pub. No.: US 2020/0109632 A1
(43) Pub. Date: Apr. 9, 2020

(54) COMPRESSOR DISC

(71) Applicant: ROLLS-ROYCE PLC, London (GB)

(72) Inventors: Kieran P. LUCEY, Derby (GB); Pierre-Antoine J. SIS, Derby (GB)

(73) Assignee: ROLLS-ROYCE PLC, London (GB)

(21) Appl. No.: 16/568,998

(22) Filed: Sep. 12, 2019

(30) Foreign Application Priority Data
Oct. 4, 2018 (GB) 1816180.2

(51) Int. Cl. F01D 5/06

(52) U.S. Cl. CPC F01D 5/06; F05D 2260/30

(57) ABSTRACT

A compressor disc includes a diaphragm portion connected to a mounting disc portion at its distal end and a cob portion at its proximal end. The cob portion having a leading edge with a shoulder section connected to an edge section at point X, a trailing edge with a shoulder section connected to an end section at point Y, and a base. Point X is offset relative to point Y in relation to the distance to the cob portion base. Point X of the cob portion may be offset relative to Point Y of the cob portion by 1 to 10 mm. Alternatively Point X of the cob portion is offset relative to point Y of the cob portion by 2 to 8 mm. the cob portion may have asymmetric widths relative to a centreline extending through a plane at the centre of the diaphragm and through into the cob.

### CROSS-REFERENCE TO RELATED APPLICATIONS

This specification is based upon and claims the benefit of priority from United Kingdom patent application number GB 1816180.2 filed on Oct. 4, 2018, the entire contents of which are incorporated herein by reference.

### BACKGROUND

### Field of the Disclosure

The disclosure relates to a mechanism for reducing the stress in a compressor cob used in a gas turbine engine.

### Description of the Related Art

Gas turbine engines incorporate a number of compressor and turbine stages, in order to compress the air prior to combustion, in the case of compressors, then to convert the exhaust gas into rotational motion in the case of turbines. In both compressors and turbines the aerofoils that interact with the air flow are secured onto individual discs. These discs or bladed disks are formed with the aerofoil being connected to the compressor mounting disc, also known as a rim. The mounting disc is in turn connected to a diaphragm that extends radially outwards from a cob at its base. The cob and the diaphragm are typically constructed of a single piece forging or casting with the width of the cob being narrowed into the diaphragm at a pair of shoulders. This connection system is the same on both the turbine discs and compressor discs. However, the cobs for compressors and turbines are quite different as the turbine cob is required to support a number of other components such as the drive arms. Consequently the shape of a turbine cob is greatly governed by the requirement to support these components, whilst at the same time allowing air to flow around them. On the other hand, compressor cobs are simpler as they do not have such requirements. Consequently, the design of these components has barely changed over time. In the prior art systems compressor cobs are designed to be symmetrical as this is considered to be the optimum way controlling the stress within these components. This stress control is important, as it plays a significant role in the lifetime of components mounted in an engine.

Despite their relatively simple design, the stress requirements of a compressor cob are quite complex as they have to be strong enough to withstand large stresses from the operating conditions within the engine. The stresses in the cob can be the result, among other issues, of thermal effects due to one side of the cob being hotter than the other, differences in airflow, or as the result of bending due to rotor level dynamics. If the stress is not properly managed it can become an issue that may limit the lifetime of the component. In the case of a bladed disc as used in a compressor a common point of failure is within the cob. Therefore, it is desirable to reduce stress in the cob and to further reduces it at other points along the diaphragm.

### SUMMARY OF THE DISCLOSURE

According to a first aspect there is provided a compressor disc comprising: a diaphragm portion connected to a mounting disc portion at its distal end and a cob portion at its proximal end; the cob portion having a leading edge comprising a shoulder section connected to an edge section at point X, a trailing edge comprising a shoulder section connected to an end section at point Y, and a base; and wherein point X is offset relative to point Y in relation to the distance to the base of the cob portion.

The modification of the shape of the cob in this way has been found to produce the desirable effect of moving the stress closer to the centreline. This centreline extends along a plane that runs through the length of the diaphragm at its geometrical centre and into the cob. Thus, by changing cross sectional shape of the cob and creating an asymmetry in the height of the shoulder sections it has the desirable effect of increasing the mass in certain areas of the cob. If these sections are located in portions of the cob that are close to areas of peak stress it can have the effect of moving the stress away from an edge. Moving the stress away from the edge and to the centre of the component will have the beneficial effect of reducing the risk of failure in the component, which can result in the engine being kept on the wing longer. Furthermore, by adding the extra material to an area that is more likely to fail will also strengthen the component.

The shoulder sections of the leading and trailing edges of the cob portion may have the same radius of curvature.

The shoulder sections of the leading edge of the cob portion may have a radius of curvature that is different to that of the shoulder section of the trailing edge of the cob portion.

Point X of the cob portion may be offset relative to Point Y of the cob portion by 1 to 10 mm.

Point X of the cob portion may be offset relative to point Y of the cob portion by 2 to 8 mm.

Point X on the leading edge of the cob portion may be separated from the base by a greater distance than Point Y on the trailing edge relative to the base.

The cob may have asymmetric widths relative to a centreline extending through a plane at the centre of the diaphragm and through into the cob.

An aperture may be formed in the diaphragm portion through which a fastener is insertable to secure the diaphragm portion to the mounting disc portion.

The compressor disc may be incorporated into a gas turbine engine.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 shows an example of a prior art compressor disc;

FIG. 3 shows the stress distribution in a prior art cob;

FIG. 4 shows the stress distribution in a modified cob of a compressor disc of the present disclosure with reduced stress levels;

FIG. 5 shows a comparison of the prior art cob with the modified cob of a compressor disc of the present disclosure, clearly showing the offset in shoulder sections heights relative to the prior art version;

FIGS. 6a and 6b are graphs showing the changes in peak cob stress and peak surface stress respectively, relative an offset in height of shoulder sections.

### DETAILED DESCRIPTION OF THE DISCLOSURE

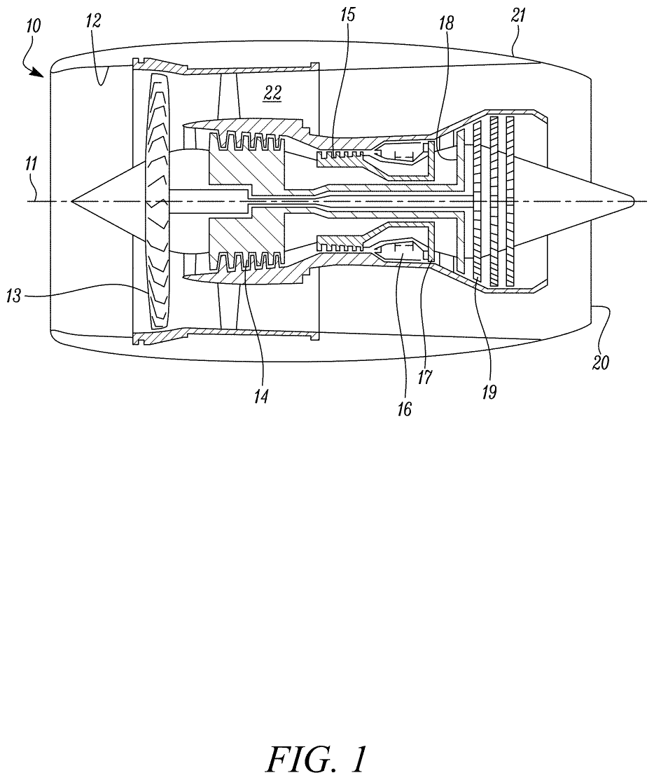

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The Intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

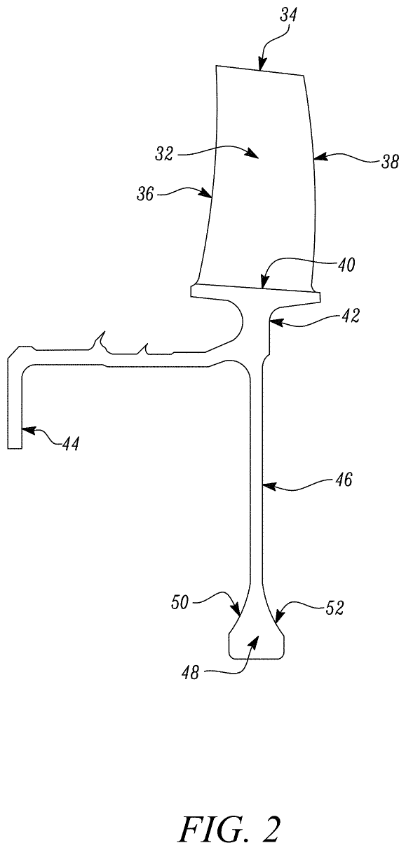

FIG. 2 presents a prior art example of a compressor disc 30. In this the aerofoil 32 has a tip 34, and leading and trailing edges 36 and 38 respectively. It is the rotation of these aerofoils that accelerates the air as they are rotated to force the air onto an adjacent row of stator vanes, where the air is decelerated. This change in kinetic energy of the air from the rotating compressor blades to the stator translates into a pressure rise in the air. The blades are connected to the compressor disc at a neck. The neck is part of the mounting disc to which is connected the front flange 44. The drive shaft is coupled to the mounting disc, which is in turn connected to the cob through an intermediate diaphragm. The cob portion extends radially inwards from the diaphragm from a pair of curved shoulder sections 50 and 52 on the leading and trailing edges respectively. Both of these shoulder sections have a radius of curvature.

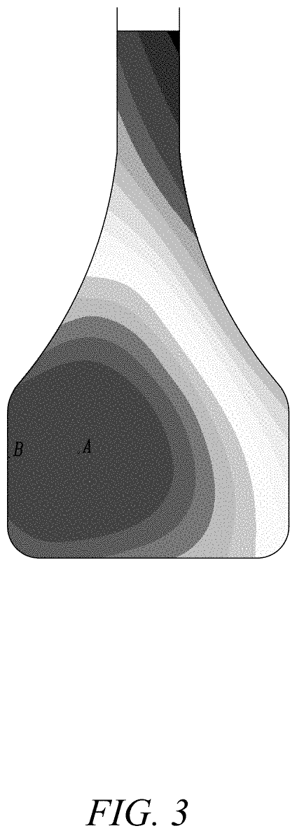

In order to overcome the conflicting issues, of maintaining or reducing the mass with better stress management, it has been found that redistributing the mass through altering the shape of the cob in an asymmetric way can bring about the desired effect. In this case, reference to an asymmetric cob means that the profile of the cob is not symmetrical about a centreline extending through a plane at the centre of the diaphragm and through into the cob. This configuration is beneficial particularly in situations where the stress distribution is asymmetric as the shaping of the cob may localise and reduce the stress within the cob. FIG. 3 shows the stress distribution in a prior art cob, which is symmetric about the centreline. In the figure the darker shading corresponds to regions of greater stress. As can be seen from the figure, the point of peak stress—point A—is located in front of the centreline; this reference is in relation to the orientation of the engine in operation. Furthermore, the area of elevated stress also extends to the surface of the base at point B—the point of highest surface stress. Point B is located on an end section of the leading edge of the cob portion. The high stress area extending from a point of peak component stress to the peak surface stress could eventually result in component failure. This is because an area featuring a high stress level profile which is distributed across from the location of peak component stress to the surface is a feature in low cycle fatigue and handling damage tolerance. Furthermore, it is also beneficial in the reduction of the risk of failure due to melt anomalies because the peak stress in the component is lower and the region of high stress is less within the area. This is also beneficial for the integrity of the component and of the engine itself in case of overspeed events. In contrast at the opposing side of the cob the stress values are significantly lower.

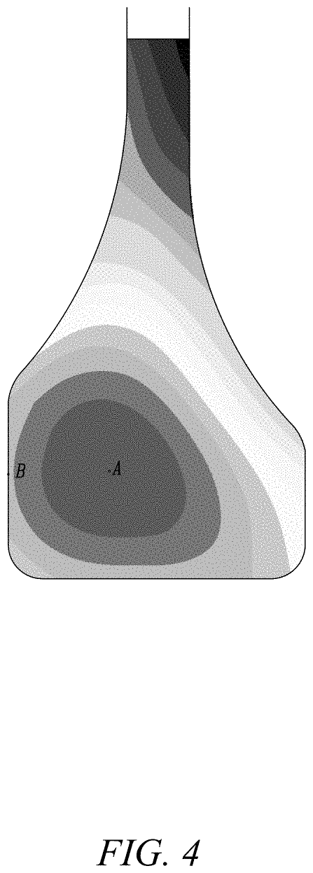

In order to move this stress away from the edge of the component it is desirable to add mass to the side where the peak stress is highest. Typically, any addition of mass will be carried out symmetrically, so that the mass of the component will increase. Instead of this, it would be desirable to maintain the mass of the component, whilst at the same the reducing the stress in the component. To overcome these issues the cob may instead be made asymmetric about its centreline. As shown in FIG. 4, this is done by altering the shoulder profile of the cob. This can be either from increasing the height of the shoulder section closest to the peak stress, or lowering the shoulder section furthest away from the peak stress or a combination of the two. In FIG. 4 it is shown that by raising the leading edge shoulder section, which is at the side closest to point of peak stress, and reducing the height of trailing edge shoulder section the peak stress distribution can be moved towards the centreline. The movement of the area of peak stress towards the centreline is desirable in controlling stress levels within the cob. The results of this asymmetry in the cob profile are not only limited to the movement and localisation of the peak stress, but also cause a lowering of it. In comparison with the prior art example, the area of peak stress is now located towards the centre of the cob and no longer extends to the edge, which was an issue the prior art in symmetric cob. This reduction in the stress will result in better low cycle fatigue and damage tolerance, which would increase the lifespan of the component. Whilst the shoulder section heights are adjusted to create an asymmetric profile, the respective widths of the cob remains equal either side of the centreline. However, this is not necessarily the case. The widths of the two halves may be made to be different, which can produce a desirable effect on the stress levels of the cob.

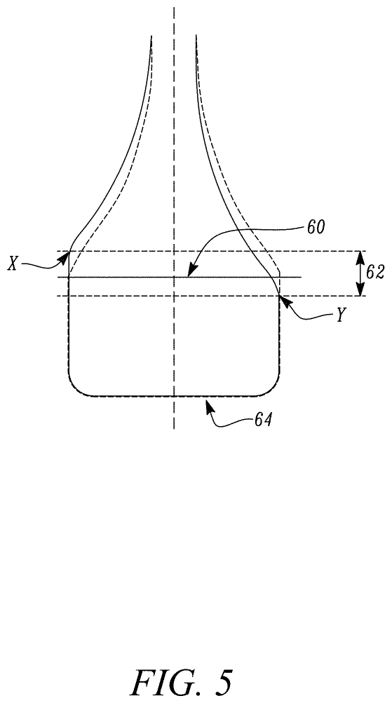

FIG. 5 shows a comparison in cross sectional profiles of the two cob designs. Line 60 demonstrates the position of the shoulder sections in the prior art symmetric cob, as shown in FIGS. 3 and 4. Line 62 demonstrates the offset in shoulder section heights relative to the base 64 section of the cob. The figure shows that there is a clear offset between shoulder section heights on the leading edge starting at point X and that of the trailing edge point Y relative to the distance to the base of the cob. In this case the measurement regarding the positioning of the offset is taken from the point at which the gradient changes from the edge of the cob into the shoulder section—labelled X and Y in the figure. The radius of curvature of these shoulder sections that curve outwardly to connect the cob to the diaphragm may be the same or different. The centreline 66 of the cob is also shown.

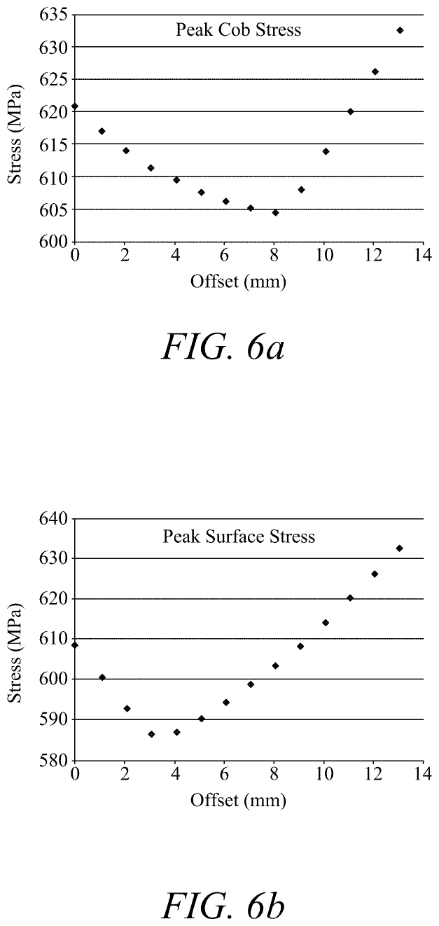

FIG. 6a shows the value of the peak cob stress relative to the offset measurement, where the offset is the difference in axial height between points X and Y. As can be clearly seen in this there is a general decrease in the stress as the offset is increased from 0 to 8 mm, however after this the benefit of increasing the offset become less as the stress starts to increase. At 11 mm the stress is approximately the same as it is for a zero offset, and after that there are no benefits at all to having an offset. FIG. 6b, presents the same Information relative to the peak surface stress. In this case, there is a decrease in the stress levels until about 3-4 mm before this starts to increase again. At 9 mm the stress is equivalent to the same system without an offset and after this point, there is no benefit to be gained. Consequently, offsetting one of the shoulder sections a distance between 1-10 mm leads to an improvement in the stress values. A greater improvement is seen in the narrower range of 2-8 mm. For peak stress the should be offset by 5-9 mm. For peak surface stress the offset should be between 2-5 mm. Although in the example the offset is provided with the leading shoulder being raised, it equally may be applied that the trailing edge is raised.

As discussed, this offset can be produced by raising or lowering one of the shoulder sections with respect to the other. The leading edge can be raised with respect to the trailing edge. Alternatively, it can be done by a combination of raising one shoulder section and lowering the other relative to a prior art symmetrical cob. The leading edge may be raised, and the trailing edge may be lowered. The latter option has been found to provide the greatest improvement in stress management. This is because it allows the stresses to be balanced whilst keeping the weight constant. Alternatively if the stress level is maintained the weight of the cob may be decreased by reducing material from the both shoulders in a non-symmetrical manner. This process for optimising the shoulder heights has been found to reduce the peak stress in both the cob and at the surface. It has further been found to reduce the volume of higher stressed material, which can reduce the chance of melt anomalies. Similarly, it can move the peak stress away from the surface, thus increasing the damage tolerance of the component. This is beneficial in controlling melt anomalies within the cob and also reduce the low cycle fatigue in the component. The effects of these benefits also improve the integrity of the component in case of overspeed events.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A compressor disc comprising: a diaphragm portion connected to a mounting disc portion at its distal end and a cob portion at its proximal end;
the cob portion having a leading edge comprising a shoulder section connected to an edge section at point X, a trailing edge comprising a shoulder section connected to an end section at point Y, and a base; and
wherein point X is offset relative to point Y in relation to the distance to the base of the cob portion.

2. The compressor disc as claimed in claim 1, wherein the shoulder sections of the leading and trailing edges of the cob portion have the same radius of curvature.

3. The compressor disc as claimed in claim 1, wherein the shoulder section of the leading edge of the cob portion has a radius of the curvature that is different to that of the shoulder section of the trailing edge of the cob portion.

4. The compressor disc as claimed in claim 1, wherein Point X of the cob portion is offset relative to Point Y of the cob portion by 1 to 10 mm.

5. The compressor disc as claimed in claim 4, wherein Point X of the cob portion is offset relative to point Y of the cob portion by 2 to 8 mm.

6. The compressor disc as claimed in claim 1, wherein the cob portion has asymmetric widths relative to a centreline extending through a plane at the centre of the diaphragm and through into the cob.

7. The compressor disc as claimed in claim 1, wherein Point X on the leading edge of the cob portion is separated from the base by a greater distance than Point Y on the trailing edge is from the base.

8. The compressor disc as claimed in claim 1, wherein an aperture is formed in the diaphragm portion through which a fastener is insertable to secure the diaphragm portion to the mounting disc portion.

9. A gas turbine engine comprising at least one compressor disc as claimed in claim 1.
